(19) United States
(12) Patent Application Publication
(10) Pub. No.: US 2008/0071716 A1
(43) Pub. Date: Mar. 20, 2008

(54) Apparatus and method of planning through generation of multiple efficient plans

(76) Inventors: Kay Schwendimann Anderson, Washington, DC (US); Genady Ya. Grabarnik, Scarsdale, NY (US); Nagui Halim, Yorktown Heights, NY (US); Zhen Liu, Tarrytown, NY (US); Anton Viktorovich Riabov, Ossining, NY (US)

Correspondence Address: F. CHAU & ASSOCIATES, LLC, 130 WOODBURY ROAD, WOODBURY, NY, 11797, US

(21) Appl. No.: 11/513,924

(22) Filed: Aug. 31, 2006

(51) Int. Cl. G06N 5/00

(52) U.S. Cl. 706/45

(57) ABSTRACT

A method and apparatus for solving a planning problem generates multiple efficient, alternate plans, one of which is selected for execution. Cost and quality metrics are used for describing and comparing the multiple plans. A planner narrows down a large number of possible solutions or plans to solve the problem based on a domain description including parameters that play a role in cost and quality computation. The method and apparatus can be used in planning stream processing workflows, threat detection and prevention, including intrusion detection, travel planning and planetary exploration.

### GOVERNMENT LICENSE RIGHTS

This invention was made with Government support under Contract No. H98230-04-3-001 awarded by the U.S. Department of Defense. The Government has certain rights in this invention.

### TECHNICAL FIELD OF THE INVENTION

The present disclosure relates to automatic planning whereby an optimum plan is to be chosen and executed from among a number of various choices and approaches.

### BACKGROUND

Automatic planners have been an active area of research in the Artificial Intelligence field of computer science since the 1960s. Broadly, these systems can be defined as software programs whose responsibility it is to decide which actions should be taken for achieving a specified goal, given a description of the planning domain including possible actions and the initial state of the project. A sequence or a partially ordered set of chosen actions, together with necessary parameter values, constitutes a plan. In the following plan, any that achieves the goal and satisfies other constraints imposed by the application domain is referred to as a candidate plan. The plans presented by the planning system as a result of planning are referred to in the following as resulting plans.

The automatic planners are typically used in a process that has at least two phases, for example, (1) generate a plan, usually performed using automatic planner, and (2) execute the plan; In general, the steps (1) and (2) can be repeated in order to react to changing conditions through re-planning. The plans are typically implemented or executed using some kind of a system-dependent plan execution method.

In many application domains, more than one candidate plan can be used to achieve the desired goal. Classical automatic planners developed to date, however, traditionally produce a single resulting plan. In some of these planners, the resulting plan is chosen arbitrarily, and in some systems, called optimal planners, a certain preference is given to the candidate plans with a small total number of actions, although typically no guarantee of completeness is provided. Recently, with the increase in efficiency of planning methods and increasingly affordable computation power, there has been increasing interest in metric planning methods, where the planning system can compute different numeric metrics of a plan using domain-specific formulas.

Metric planners allow defining constraints on these metrics, which are used to restrict the set of candidate plans to include only those satisfying the constraints. Optimal metric planners in addition to metric constraints allow specifying a metric optimization objective, that is, a mathematical expression involving plan metrics. The resulting plan produced by the optimal metric planner for planning problems that specify an optimization objective must have the optimal, that is, the minimum or maximum, depending on the planning goal, value of the metric expression among all candidate plans. In practice, however, state-of-the-art optimal planners often produce a sub-optimal resulting plan due to the complexity of the problem and the limited time and memory available to the planners for exploring alternative candidate plans.

Other related areas of research in this field are contingent planning, conformant planning and oversubscription planning. A conformant planner generates a plan that can be executed without change under a variety of initial conditions. A contingent planner generates a plan that includes conditional branches describing reaction to changing conditions. For example, it may describe action sequences for recovery after an action fails, as well as the sequence of actions that must be executed under normal circumstances. In oversubscription planning, which is also called partial satisfaction planning, a class of planning problems that has only recently been defined and has started attracting increasing attention of researchers, the plans must achieve an optimal subset of goals. In these problems, generally, all of the multiple goals cannot be satisfied, because of constraints on the plans, such as cost constraints.

In a wide range of application domains, plan metrics can be classified either as resource cost metrics or quality metrics, as in oversubscription planning. A cost metric is an application-dependent measure of costs that must be incurred, time that is spent, or resources that are temporarily allocated or permanently expended, during execution of the plan. If the same result can be achieved with a smaller cost, the plan achieving the smaller cost should be preferred. A quality metric is an application-dependent measure characterizing preferences of the end-user with respect to the generated plans, which can be based on an estimate of the benefit, value, quality, profit or utility that execution of the plan will provide, as well as on the timeliness of completion of the plan. In general, end-users of the planner will usually prefer higher quality plans to lower quality ones.

### SUMMARY OF THE INVENTION

Exemplary embodiments of the present invention provide an automatic planner generating multiple alternative plans. The multiple resulting plans can be produced only if multiple candidate plans exist. This planner can be used as part of a three-step process, including (1) generate multiple resulting plans using an automatic planner, (2) choose one of the resulting plans and (3) execute the chosen plan.

Further, the inventive planner involves the use of cost and quality metrics for describing and comparing plans. The planner produces multiple plans, such that the resulting plans have different ranges of cost and quality. Cost and quality can be real numbers or can be multidimensional vectors of real numbers. If it is necessary to compare costs or qualities of different plans, the corresponding vectors are compared component-wise. Each of the multiple resulting plans is efficient according to the following definition:
A plan P is efficient if there are no candidate plans with different costs and/or quality, and which at the same time have equal or greater quality and equal or lower cost compared to plan P.

The plan efficiency requirement ensures that inefficient or obviously wasteful plans are not returned as resulting plans by the planner. In other words, the resulting plans produced by the planner must be optimal in their range of quality or cost. On the other hand, the efficiency condition should not always be viewed as a strict global optimality requirement. In some implementations of the present invention, near-optimal approximate solutions produced by heuristics are acceptable, even in cases where the actual quality of the approximation cannot be estimated. The definition of an efficient plan according to the present invention can be revised to accommodate best-effort efficiency.

The present inventive planning method provides the tools required to explore the set of efficient candidate plans. The planner can select only a small set of the most representative, that is, the most diverse in cost and quality, plans from the set of efficient candidate plans and return them as resulting plans. The number of plans returned and other parameters, such as the resource and quality ranges from which plans are selected, can be specified as planner parameters.

In summary, the inventive planning method produces a relatively small set of resulting plans that are: (1) efficient, and (2) diverse in cost and quality, and if desired within a specified interval.

The following are some of the benefits obtainable in practicing the inventive method.

Users gain access to the planning process which allows them to select one plan from a set of diverse efficient plans after initial processing by the automatic planner. It has been found that people often prefer choosing from a small number of options to other methods of specifying preferences.

By examining the set of resulting plans, the users can explore the space of possible tradeoffs between cost and quality of plans, as well as the tradeoffs between multiple different components of cost and quality vectors.

The users familiar with the domain can study tradeoffs between cost and quality by examining the actions included in the resulting plans. For these users, the domain-specific semantics of actions can help explain the tradeoffs obtained by the planner.

Automatic analysis procedure can perform a thorough review of the small set of diverse alternative plans produced by the planner and then choose the best option. This becomes important when the required analysis procedure cannot be performed on the full set of candidate plans, because it results in a computation that is too time-consuming when a large set of plans is analyzed.

The set of efficient plans can also be used for identifying errors in domain description. The structure of plans selected by the planner within a range of quality and cost of interest can be studied to gain insight into decisions made by the planner and can identify the fragments of domain description that served as the basis for making these decisions.

The present method can be applied in the following areas. Planning of grid or stream processing workflows, or other applications that require instant re-planning for changing resource availability, for example, via switching to an alternative plan. Threat detection and prevention, including intrusion detection applications, for example, via analysis of multiple efficient plans of attack. Numerous applications areas of oversubscribed planning problems, such as robotics, logistics, project planning, travel planning, and even planetary exploration. All other applications of planning under cost and quality constraints can be improved by following the herein described methods.

### BRIEF DESCRIPTION OF THE DRAWINGS

FIG. 1 is a schematic representation of performing a plan review before submission according to an exemplary embodiment of the present invention.

FIG. 2 is a schematic representation of performing a semi-automatic plan review according to an exemplary embodiment of the present invention.

FIG. 3 is a schematic representation of exploring the set of efficient plans according to an exemplary embodiment of the present invention.

### DETAILED DESCRIPTION OF EXEMPLARY EMBODIMENTS

In the following, the business processes that require the use of multiple alternative plans are described. Next, the interval approach to generating multiple plans is described. Finally, a search-based planning algorithm for generating multiple alternative optimal plans within the interval approach is described.

In the plan-review-before-submission scenario, the user receives a set of alternative plans from the planner, and chooses one of the plans for execution based on cost/quality tradeoffs.

Users of the system can choose the plan to be executed from a limited set of possible alternatives. The users make their choice after the planner has narrowed down the huge set of possibilities, that is, the numerous candidate plans, and has selected only a few resulting plans that represent wide ranges of cost and quality values. The capability of the system to provide this choice is especially valuable in environments where users are responsible for managing resources allocated from limited budgets. In these systems the users must balance resource allocation between multiple tasks they plan and perform, based on relative priority and expected quality of results.

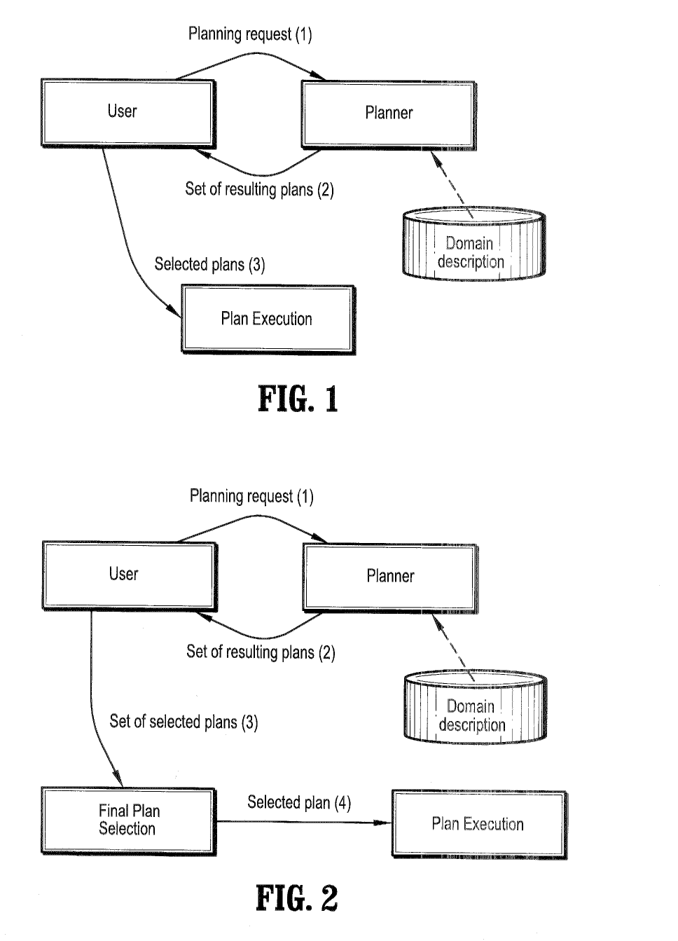

As shown in FIG. 1, a user 10 submits a planning request (1) to the planner 02. The contents and format of the planning request are specific to each particular implementation of the planner. The planning request must contain a description of the goal that must be achieved by the plan, and can optionally contain other information, including preferences, constraints and an initial state.

The planner 20, uses a domain description from a store 30 of various domain descriptions and the planning request (1) as input data, generates a set of efficient plans and returns the set of plans (2) to the user 10. The planning domain description contains definitions of actions, and possibly other parameters of the planning task. Each of the resulting plans returned to the user 10 is annotated with cost and quality values computed by the planner 20. It is possible, of course, that no plans satisfying the planning request (1) exist, in which case the planner 20 will return an empty set of plans.

The user 10 then inspects the set of returned plans (2). The plans returned by the planner 20 cover a wide range of quality and/or costs and, therefore, the user 10 can study the tradeoffs between the different costs, for example, the monetary costs or the use of critical resources, and the quality of the end results produced by the plan. The user 10 may also at this point request to view the complete or partial sets of actions constituting the plan to gain a better understanding of the implications of the tradeoffs. Finally, the user 10 decides which of the alternative plans she prefers, and submits the preferred plan for execution (3) by the appropriate plan execution system 40. Alternatively, at this point the user 10 may decide not to submit any plans. In that case, the user 10 may revise and re-submit the planning request (1) to the planner 20.

According to an embodiment of the present invention, it is also possible to improve the efficiency of the planning processes as described in connection with FIG. 1 based on the following.

The users 10 are provided with a clear view of tradeoffs between cost and quality, shown by representative plans covering a wide range of cost and quality values as provided by the planner 20.

In addition to the numeric cost and quality metrics, the tradeoffs are illustrated by the different sets of domain-specific actions that are included in the set of resulting plans (2). The users 10 that are familiar with the domain as included in the domain description 30 can gain a better understanding of the tradeoffs by studying the set of resulting plans (2).

In a straightforward alternative to the above-described method, which can be implemented using existing metric planners, is the automatic choice of the plan for execution made based on a user-defined utility function. In practice, however, it has been found that people often feel more comfortable choosing from a number of possible options, rather than describing their preferences by specifying a utility function.

A modification of the system operation of FIG. 1, described above, is shown in FIG. 2, in which the plan chosen for execution is selected automatically or semi-automatically, after a detailed analysis of a resulting set of plans produced by the planner.

A fully or partially automated selection of plans can be performed after the resulting set of plans has been produced by the planner. Optionally, the users may reduce the set of plans by removing the plans they view as unacceptable and leaving the final choice of the plan selected for execution to an automatic system. Since at this stage the system has to choose among a smaller number of plans, it can perform extensive analysis for each of the plans in much more detail than the planner, which has to consider a possibly very large set of candidate plans and, therefore, has very limited time and resources available to analyze each plan.

The process consists of the following steps, as shown on FIG. 2: the user 10 submits a planning request (1) to the planner 20, as in the system operation shown in FIG. 1, and the planner 20, as described earlier, employing a domain description 30 solves the planning problem and returns a set of efficient resulting plans (2) to the user 10. The user 10 reviews the plans, and submits a set of satisfactory selected plans (3) for final selection by a final plan selection unit 50. As in the system operation described in relation to FIG. 1, each plan is annotated with cost and quality metrics computed by the planner 20, and the user 10 may view the structure of each plan, for example, the corresponding sets of actions. The user review step is optional—the user may simply send the entire set of resulting plans (2) from the planner 20 directly to final plan selection stage 50. The difference from the procedure described earlier is that the user 10 selects not one plan, but a set of plans, from which an automatic procedure 50 further selects a single plan for execution 40. An automatic procedure, that is, an algorithm, is used to select one plan from the set of plausible plans. After a single best plan has been selected, the selected plan (4) is submitted for execution to the plan execution unit 40.

The set of selected plans (3) submitted for final selection is typically much smaller in number than the set of candidate plans considered by the planner. On the other hand, this set represents diverse plans representing various tradeoffs between cost and quality and does not contain obviously inefficient plans due to plan optimality property. Because of the small plan set size, the selection procedure applied at this step can spend more computational resources on the analysis of each plan than the planner spends on the analysis of each candidate plan. Therefore, a more detailed analysis can be performed, although at a coarser granularity of plans, when compared to the analysis of plan candidates performed by the planner. The overall process according to this feature of the present invention achieves the best balance between system performance and quality of the plan chosen for execution.

In an exemplary embodiment, the automatic procedure of selecting one plan from the set of plausible plans can be performed by the scheduler, that is, the component of the system responsible for scheduling. The scheduler allocates resources for plan execution. During plan selection the scheduler performs detailed analysis of resource utilization for each of the candidate plans, and selects the one that is the most appropriate given current resource availability. This separation of functionality between the planner and the scheduler improves planning performance by allowing the use of a coarse-grained resource model during planning, and taking further resource considerations into account when scheduling.

During this process the number of the set of plans is gradually reduced following a sequence, such as listed hereafter, in which a subsequent set is a subset of the set preceding it in the sequence: (1) candidate plans, (2) resulting plans selected by the planner, (3) plans selected by the user, and (4) the plan selected for execution, as shown in connection with FIG. 2. The process is terminated before plan execution if any one of the sets becomes empty.

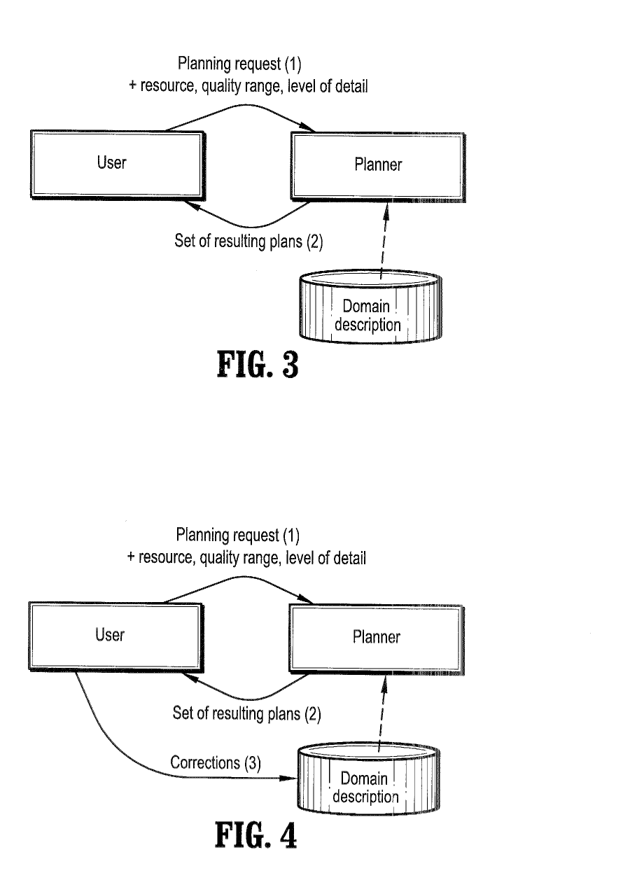

In accordance with an exemplary embodiment of the present invention as represented in FIG. 3, the users 10 can explore the space of efficient plans by submitting to the planner 20 a sequence of requests for plans (1) representing varying ranges of resources and quality. The users 10 may also control the level of detail, specifying their preferences with respect to the number of resulting plans (2) returned by the planner (20). Since the exact number of efficient plans in the region defined by the cost and quality bounds is unknown, the planner 20 may return less than the requested number of plans.

The set of efficient plans provided by the planner 20 may be used for multiple different purposes. In the domains where the plans model the behavior of an agent, which strives to achieve a certain goal, studying the set of efficient plans can help, for example, to test the defense or hedging strategies used against adversary agents. In the same domains, the set of efficient plans can also be used to train systems that predict the behavior of an agent and to detect sequences of actions that can be leading up to a particular goal. As described in the following, studying this set also can help to identify errors in the domain descriptions as stored in the domain description storage unit 30.

To enable the exploration of the set of efficient plans, the planner 20 should still return to the user 10 a relatively small, and easily observable, number of diverse plans. The user 10 should be able to specify a preferred number of plans to be returned by the planner 20. At the same time, the planner 20 should allow planning requests requiring that all returned plans belong to specified ranges of quality and cost, which is needed when the user 10 needs to selectively increase the level of detail.

One application of the exemplary embodiment of the present invention is that the set of efficient plans can be used for attack detection and prevention, with intended applications in intrusion detection. If actions in the planning domain describe the actions of attackers, then multiple efficient plans of attack can be automatically generated using the method of the present invention. Efficient plans use the minimally necessary amount of resources for achieving the goal with corresponding quality, and in many domains, for example, where each action incurs cost, do not contain redundant actions as a consequence. Resulting plans of attack produced by the planner 20 can be used to test resilience of a target to the attacks and to detect ongoing attacks based on observations of partially completed plans in progress.

The set of resulting plans (2) can be used to study the impact of planning domain parameters, such as parameters that play a role in cost and quality computation, on the set of candidate plans considered by the planner. If the number of resulting plans can be controlled, using the planner iteratively, and producing more and more resulting plans will provide more and more details about the set of candidate plans by returning more and more representatives of this set. If the planner implementation allows, an increasing level of detail could be requested specifically for the regions of cost and quality in which problems, such as unexpected choices made by the planner, are occurring. With this approach, a planner producing multiple solutions can be used for identifying and resolving problems in domain definition, as represented in FIG. 4.

The process of identifying and correcting errors in the domain descriptions consists of the following steps, as represented in FIG. 4. The user 10 submits a planning request (1), and the request includes desired ranges of cost and quality for resulting plans. It may also include the desired number of plans, which controls the level of detail. The user 10 determines these parameters based on observed abnormal behavior and other considerations. The planner 20 returns to the user 10 the set of resulting plans (2) that satisfy the criteria specified by the user. The number of plans in the set of resulting plans (2) returned may be less than the requested number of plans. The user 10 studies the resulting plans, and may submit to the planner 20 another planning request (1) or make corrections to domain description (3) as stored in the domain description storage unit 30. After making corrections, the user 10 may again submit a planning request (1) to the planner 20.

In some applications of planning it is desirable to produce plans that achieve multiple goals, some of which are optional. Achieving the optional goals contributes to the overall quality of the solution, but it may also increase the cost of the plan.

This situation can be easily represented as a problem of planning with a single or mandatory goal, in which the optional goals are represented by preconditions for special-purpose actions that have the only effect of increasing the overall plan quality value. The efficient plans, by definition, will achieve the optimal subset of optional goals for corresponding cost.

In summary, the method of generating multiple efficient plans can be used for planning with optional goals without modification. Minor changes to the planning domain description may be made in order to represent optional goals via dummy actions. The overall approach of planning with optional goals can be supported in all the situations described above.

The problems of planning with optional goals are most directly related to recent work on oversubscription planning and planning with goal preferences, as described hereinabove. A main difference between previously proposed systems and the exemplary embodiments of the present invention is that multiple plans are created for different ranges of constraints in the present invention. Also, exemplary embodiments of the present invention do not require resource or quality measures to be tied to goals, instead any method of evaluating resources and quality of plans is acceptable and may be used.

The methods of planning for oversubscribed problems can be used to generate efficient candidate plans, as part of the algorithm described in detail herein below. Partial order quality models, as well as more common numeric quality models, can be accommodated by embodiments of the present invention, since component-wise comparison of quality vectors defines a partial order, and the definition of efficient plans for partial order quality, as provided by exemplary embodiments of the present invention.

According to an exemplary embodiment the present invention, a cost interval approach is one of several methods of generating multiple efficient plans for the same planning task. The advantages of the cost interval approach are simplicity of implementation and a natural method of presenting the resulting set of plans, which is especially important when the set must be inspected by human users.

The cost interval approach can be applied under the conditions where the quality of a plan is a real number, and the cost of a plan is a multi-dimensional vector of real numbers.

Planners using the cost interval approach produce efficient plans, which have optimal or near-optimal quality for the corresponding resource range. It is essential for this approach that the quality measure has total ordering, and every pair of plans can be compared.

The cost interval approach consists of the following three steps. (1) Dividing the range of cost values in each dimension of the plan cost vector into a finite number of non-overlapping intervals spanning the entire range. The intervals can have the same length, or can be arbitrarily selected, or specified by the user, or computed using other methods. As a result, this procedure generates a grid in the space of cost vectors. Each cell of this grid is a multidimensional rectangle, the projection of which onto each cost dimension is one of the cost intervals corresponding to that dimension. (2) For each cell of this grid, finding one plan that has the highest or close-to-highest quality among all plans for which the cost vector falls within the cell. This plan is referred to herein as the selected plan for this cell. If there are no plans that have a cost vector within the cell, the cell remains empty. (3) For each non-empty cell, comparing the quality of the plan chosen in that cell to the quality of plans selected in non-empty cells that correspond to the same or lower cost in each dimension. If one of the plans in the lower-cost cells have the same or higher quality as the higher-cost plan, the higher-cost plan is removed from its cell, and the cell becomes empty.

Step (2) above ensures that the selected plans are quality-optimal within their cells. Step (3) above guarantees that after elimination the remaining selected plans are quality-optimal within the entire range of costs. Therefore, the remaining selected plans, or any subset thereof, can be returned by the planner as the set of resulting plans. It should be understood that the Steps (2) and (3) can be combined into one step, and the elimination of inefficient plans in Step (3) can be performed at any point during the search for best plans in the cells, as performed in step (2). In addition, step (2) can be performed separately for each cell, as well as in parallel for multiple cells.

The interval grid in the space of cost vectors can be provided as a parameter to the planning algorithm, which provides a method of controlling the density of the resulting solutions in the cost space. Finer interval grids can be used to request more solutions from the planner, and a higher concentration of intervals in regions of interest can be used to study the properties of the candidate plan set defined by the domain description and the planning problem description. Such analysis can be used for eliminating problems in domain descriptions and planning problem descriptions.

The set of resulting plans can be visualized using the grid structure generated at step (1), above. The visualization method relies on the fact that each cell of the grid contains at most one selected plan. In the case of a two-dimensional cost vector, the plans can be visualized using a table, as shown below:

| | Cost1: 0–50 | Cost1: 50–100 | Cost1: 100–200 |
|---|---|---|---|
| Cost2: 0–40 | (no plan) | Plan A, | Plan B, |
| | | Quality = 40 | Quality = 50 |
| Cost2: 40–80 | Plan C, | Plan D, | Plan E, |
| | Quality = 30 | Quality = 45 | Quality = 60 |

In such a table, the words “Plan A” and “Plan B” can be replaced by an actual rendering of a plan, or by a hyperlink or a button activation of which will show a detailed rendering of the plan to the user. Visualization methods used in rendering a single plan can be general or application dependent and can be developed separately.

If projection of the grid onto one of the intervals in one of the dimensions does not contain any selected plans, that is, for cost dimension d and interval i_{d} with the range of cost values [x(i_{d}), x(i_{d}+1)] each cell of the grid corresponding to that interval is empty after the elimination step, (3), is completed, and the interval can be merged with a neighboring (higher- or lower-cost) interval. In one case, the intervals [x(i_{d}), x(i_{d}+1)] and [x(i_{d}+1), x(i_{d}+2)] are replaced by [x(i_{d}), x(i_{d}+2)], and selected plans from cells corresponding to the interval [x(i_{d}+1), x(i_{d}+2)] are assigned to the cells formed by the new interval with the corresponding intervals on other dimensions. This procedure can be repeated until no empty intervals remain, and the most compact representation is obtained.

When the cost vector has more than 2 dimensions, multiple tables or a three-dimensional grid visualization based on the interval grid can be implemented.

In the following, a structure of the planning algorithm based on search is described. It is assumed that the search procedure is implemented, and it allows to enumerate all candidate plans. The outline of the main steps of the planning algorithm is set forth below.

Algorithm Plan( )

| | |
|---|---|
| 1. | Initialize grid G |
| 2. | For each candidate plan P |
| 3. | Compute q, quality of P , and c , cost of P |
| 4. | Let g be the cell of G that contains cost vector c |
| 5. | If g is empty, assign P to g |
| 6. | Otherwise, assign P to g only if quality of the plan |
| | currently assigned to g is less than q. |
| 7. | End For |
| 8. | EliminateInefficentPlans( G ) |
| 9. | Return the set of plans assigned to non-empty cells of G. |

The algorithm relies on grid data structure G that encapsulates the interval grid described above. It is a multidimensional array, which can store at most one plan in each cell. The cells correspond to multidimensional rectangles and can be addressed either by coordinates of any point that lies within the multidimensional rectangle or by cell indices.

This algorithm can be implemented on top of any search procedure that enumerates candidate plans, as described in step (2), above. Various exhaustive search methods, such as a breadth-first search and a depth-first search, have been proposed as general methods for solving combinatorial problems. These methods have also been used for planning in planners based on forward or backward search, for example.

The size of the grid can be used to control the range of the cost and quality, and the granularity of the grid, that is, the cell size, can be used to control the maximum number of plans. The number of the plans in a set returned by the algorithm described above will not exceed the number of cells in the grid. If the candidate plan P has quality or cost outside of grid range at step 4 of the above algorithm, the plan is not registered in the grid, and the iteration continues. The search procedure may use the bounds on resource and quality to perform an efficient pruning and avoid enumerating candidate plans that are outside of grid range.

Depending on the particular implementation at this point, the search may or may not be complete, that is, it may not provide a guarantee that all efficient candidate plans are enumerated. If the search is not complete, the resulting set of plans may be suboptimal, that is, it may contain plans that are not efficient. This solution, however, may still be acceptable for many purposes, especially if the search typically finds a large number of efficient plans. In some planning domains, constructing a suboptimal solution can be the only practical approach, since planning is an undecidable problem in general, and the search must be terminated after the computation time limit is reached.

The procedure of eliminating inefficient plans, EliminatelnefficentPlans(G), which is called out at Step 8 of the above Algorithm Plan( ), eliminates plans that are not efficient. This is done by verifying that the quality of each plan in the grid G dominates the quality of the plans in the lower cost cells of the same grid. All plans violating this efficiency condition are removed from this grid by this procedure. The steps of the algorithm for eliminating inefficient plans are presented below.

Algorithm EliminateInefficentPlans( G )

| | |
|---|---|
| 1. | For each plan P in grid G |
| 2. | For each plan P′ in grid G such that cost(P′) ≦ cost(P) |
| 3. | If quality(P′) ≧ quality(P) |
| 4. | Remove P from G |
| 5. | Continue loop 1 (next P). |
| 6. | End If |
| 7. | End For |
| 8. | End For |

It should be noted that the algorithms described herein are encoded at a high level, and mainly serve to show that the desired functionality can be achieved by simple code.

More efficient implementations are possible if the array structure of G is used for indexing directly. For example, grid implementation relies on a multidimensional array and, therefore, cells can be addressed with integer indices of intervals, where intervals are sorted in an increasing order, Index 0=[0,0,0, . . . ,0] will correspond to the lowest-resource cell. The dimensionality of the index vector is the same as the dimensionality of the cost vector. Then, the following more efficient algorithm implementation can be provided by the exemplary embodiment of the present invention.

Algorithm EliminateInefficentPlans2( G )

| | |
|---|---|
| 1. | Initialization: |
| | For all cell indices i let Q(i) := φ |
| | Let Q(0) := quality(plan(G,0)) |
| 2. | For all cell indices i such that Q(i) = φ and |
| | for all indices j < i Q(j) ≠ φ |
| 3. | If plan(G,i) = φ |
| 4. | Let Q(i) := max(Q(j) \| j < i) |
| 5. | Else |
| 6. | If ∃j < i such that Q(j) ≧ quality(plan(G, i)) |
| 7. | Let plan(G,i) :=φ |
| 8. | Let Q(i) := max(Q(j) \| j < i) |
| 9. | Else |
| 10. | Let Q(i) := quality(plan(G,i)) |
| 11. | End If |
| 12. | End If |
| 13. | End For |

In the above-described algorithm j [symbol] i is denoted at the relation between two cell indices i and j that is true if and only if j differs from i in exactly one element of the index vector, and the difference between this element in i and same element in j is exactly 1. In other words, this means that j is the immediate neighbor cell of i with a smaller index in exactly one dimension. The number of operations performed by this modification of the algorithm is linear in the number of cells in the grid, which is less than the quadratic number of operations in the first implementation.

Although exemplary embodiments of the invention have been described herein with reference to the accompanying drawings, it is to be understood that the invention is not limited to these exemplary embodiments, and that various other changes and modifications may be affected therein by one skilled in the art without departing from the spirit of the invention. All such changes and modifications are intended to be included within the scope of the invention as defined in the appended claims.

We claim:

1. A method for planning for solving a planning problem, comprising
receiving a planning request that contains a list of metrics that can be used for optimization including cost and/or quality metrics expressed as numeric vectors of the planning problem; and
generating multiple efficient plans for solving at least a portion of the planning problem,
wherein the multiple efficient plans have assigned thereto different respective cost and quality values with a specified range for each metric of cost and/or quality, wherein one plan from the generated multiple efficient plans is selected.

2. The method of claim 1, wherein a user of the method selects one plan from among the generated multiple plans for execution based on the assigned cost and quality values.

3. The method of claim 1, further comprising performing an automatic plan selection for selecting one plan from the generated multiple plans without a selection by a user of the method.

4. The method of claim 1, further comprising
selecting by a user operation a subset of plans from the multiple plans generated in the step of generating; and
automatically choosing one of the subset of plans without a selection operation by a user of the method.

5. The method of claim 1, wherein the step of generating multiple efficient plans includes incorporating a domain description of the planning problem when generating the multiple efficient plans.

6. The method of claim 5, further comprising detecting errors in the domain description, and eliminating detected errors before performing the step of selecting one plan.

7. The method of claim 5, wherein the planning problem includes threat detection and further comprising including a model of action of an adversary in the domain description before performing the step of selecting one plan.

8. The method of claim 5, wherein the planning problem includes threat prevention and further comprising
analyzing a resiliency of targets of attacks to the multiple efficient plans generated in the step of generating; and
including in the domain description a model of actions by an adversary before performing the step of selecting one plan.

9. The method of claim 1, further comprising:
constructing a cost and quality interval grid; and
eliminating relatively inefficient plans from the generated multiple efficient plans using the cost interval grid.

10. The method of claim 9, further comprising
interchanging cost and quality when constructing the cost and quality interval grid, wherein the grid has a plurality of quality dimensions and the cost is represented by a single number for each of the multiple efficient plans and is minimized for each cell of the grid.

11. A program storage device readable by machine, tangibly embodying a program of instructions executable by the machine to perform a method for planning for solving a planning problem, comprising
providing a planning request including cost and/or quality metrics expressed as numeric vectors of the planning problem; and
generating multiple efficient plans for solving at least a portion of the planning problem,
wherein the multiple efficient plans have assigned thereto different respective cost and quality values with a specified range for each metric of cost and/or quality, wherein one plan from the generated multiple efficient plans is selected.

12. The program storage device of claim 11, further comprising
selecting by a user operation a subset of plans from the multiple plans generated in the step of generating; and
automatically choosing one of the subset of plans without a selection operation by a user of the method.

13. The program storage device of claim 11, wherein the step of generating multiple efficient plans includes incorporating a domain description of the planning problem when generating the multiple efficient plans.

14. The program storage device of claim 11, wherein the planning problem includes threat detection and further comprising including a model of action of an adversary in the domain description.

15. The program storage device of claim 13, wherein the planning problem includes threat prevention and further comprising
analyzing a resiliency of targets of attacks to the multiple efficient plans generated in the step of generating; and
including in the domain description a model of actions by an adversary.

16. The program storage device of claim 11, further comprising:
constructing a cost and quality interval grid; and
eliminating relatively inefficient plans from the generated multiple efficient plans using the cost interval grid.

17. The program storage device of claim 16, further comprising
interchanging cost and quality when constructing the cost and quality interval grid, wherein the grid has a plurality of quality dimensions and the cost is represented by a single number for each of the multiple efficient plans and is minimized for each cell of the grid.

18. A system for providing a plan to solve a planning problem, comprising
a user unit producing a planning request including limits on resources and level of detail;
a domain description store containing a domain description related to parameters of the planning problem; and
an automatic planner receiving the planning request and receiving the domain description and generating therefrom a plurality of efficient plans provided to the user unit, wherein the plurality of efficient plans have different respective cost and/or quality values and one plan from the generated multiple plans is selected.

19. The system of claim 18, wherein the automatic planner assigns different respective cost and quality values with a specific range for each metric of cost and/or quality to each of the multiple efficient plans.

20. The system of claim 19, further comprising a final plan selection unit for selecting the one plan from the generated multiple plans for execution based on current available budgets, wherein a best quality plan that fits these budgets in terms of cost is selected.
